(19) United States
(12) Patent Application Publication
(10) Pub. No.: US 2004/0181903 A1
(43) Pub. Date: Sep. 23, 2004

(54) Adaptor for a braking deceleration device

(75) Inventor: Luciano Salice, Carimate (IT)

Correspondence Address: DILWORTH & BARRESE, LLP, 333 EARLE OVINGTON BLVD., UNIONDALE, NY, 11553, US

(73) Assignee: Arturo Salice, S.p.A.

(21) Appl. No.: 10/805,697

(22) Filed: Mar. 22, 2004

(30) Foreign Application Priority Data
Mar. 20, 2003 (DE) 203 04 498.3

(51) Int. Cl. F16D 51/00

(52) U.S. Cl. 16/82

(57) ABSTRACT

The invention relates to an adaptor for a braking deceleration device for doors or movable furniture parts, which essentially comprises a plunger which can be pushed into a housing against a braking force, with an adaptor body. According to the invention, in the adaptor body at least one accommodation recess for accommodating the housing of the braking deceleration device is made. The adaptor body comprises at least one smooth external surface by way of which it can be fixed to the frame or furniture carcass by means of a suitable adhesive.

The invention relates to an adaptor for a braking deceleration device for doors or movable furniture parts, which essentially comprises a plunger which can be pushed into a housing against a braking force, with an adaptor body.

From the European patent application EP 1 006 251 A1, braking deceleration devices are known which comprise a plunger which can be pushed into a housing or a cylinder against a braking force or damping force. The housing or cylinder is attached to the face of a frame or a furniture carcass by way of attachment means, with a particular arrangement of these attachment means, i.e. particular care during installation of the braking deceleration device, being necessary with the use of these attachment means.

It is thus the object of the present invention to provide an adaptor for installing such braking deceleration devices, which adaptor can easily be attached to the furniture carcass without requiring any preparatory work, and which adaptor ensures the desired damping effect of the braking deceleration device, without itself being of unsightly appearance.

According to the invention this object is met in that, in the adaptor body, at least one accommodation recess for accommodating the housing of the braking deceleration device is made, and in that the adaptor body comprises at least one smooth external surface by way of which it can be fixed to the frame or furniture carcass by means of a suitable adhesive. Based on this design, the adaptor can be bonded to any desirable position on the frame or furniture part. This requires neither preparatory measures nor the use of a tool. In principle, the adaptor can be attached at any desired position on the piece of furniture, for example to the bottom, cover or any other location. Preferably however, by means of the adaptor, the braking deceleration device or the damper can be attached to the sidewall of the furniture where the hinges are also arranged. To this purpose, the braking deceleration devices or dampers are filled with a liquid whose viscosity is at least 15,000 cSt and preferably 20,000 cSt. If the adaptors are attached to other positions on the piece of furniture, as explained above, damping fluid of lesser viscosity is adequate.

Further preferred embodiments of the invention are disclosed in the subordinate claims which follow the main claim. Accordingly, the adaptor body can comprise two smooth external surfaces which are essentially aligned at right angles in relation to each other. As a result of this, in the corner region of a furniture carcass, said adaptor body can be firmly connected to said furniture carcass. With this embodiment, particularly firm and stable connections are achieved. In such a design comprising two smooth external surfaces which are arranged at a right angle in relation to each other, the adaptor body can comprise an essentially triangular cross section, wherein the outer corners are preferably rounded. Preferably, two accommodation recesses can be made in the adaptor body, wherein, depending on the desired damping effect, two braking deceleration devices can be used.

According to a particularly advantageous embodiment, an adhesive tape with double-sided adhesive action can be used as an adhesive.

The front end of the accommodation recess provided in the adaptor, of which accommodation recess there is at least one, can be of pedestal-like design. In this case, the braking deceleration device comprises a rim which fits tightly into the pedestal-like recess. This makes possible simple installation with exact fit of the braking deceleration device with its housing in the accommodation recess of the adaptor. In addition, on the side on which the accommodation recess is provided, the adaptor body can comprise a circumferential rim. This rim makes possible particularly easy installation of the adaptor since when the adaptor is affixed with adhesive, this rim only needs to be flush with the external edge of the furniture carcass. In this way it can be ensured that the adaptor and thus the braking deceleration device are precisely installed at the desired position in the desired geometric alignment.

Further characteristics, details and advantages of the invention are provided in the embodiments shown in the drawings.

The following are shown:

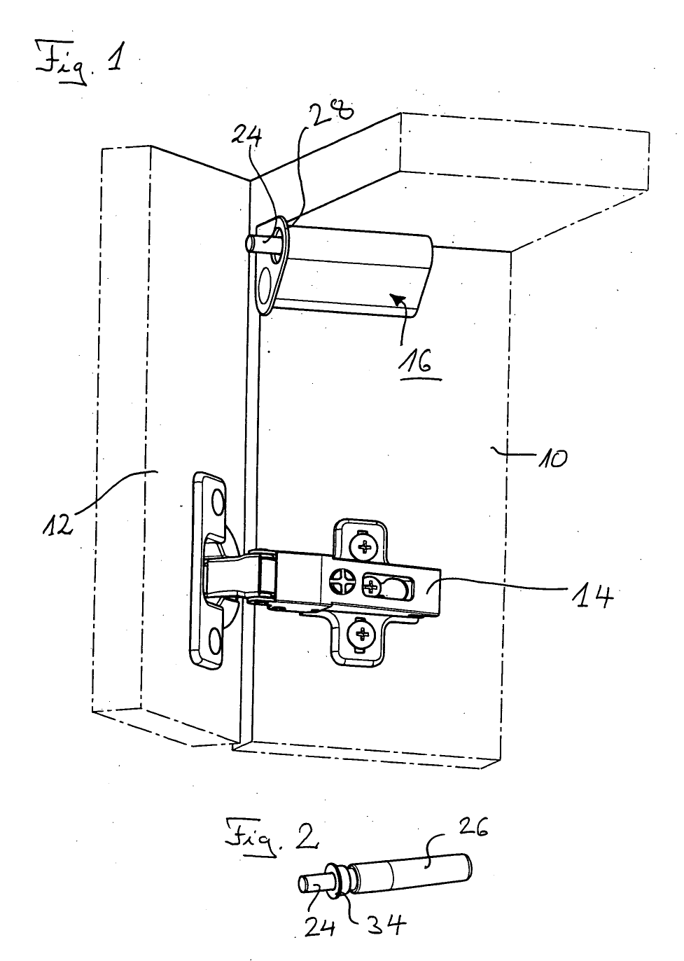

FIG. 1: a first embodiment of the adaptor according to the invention in the installed state;

FIG. 2: a braking deceleration device which can be installed with the adaptor according to the invention on the furniture carcass or frame;

FIG. 3: an alternative embodiment of the invention, similar to the view according to FIG. 1;

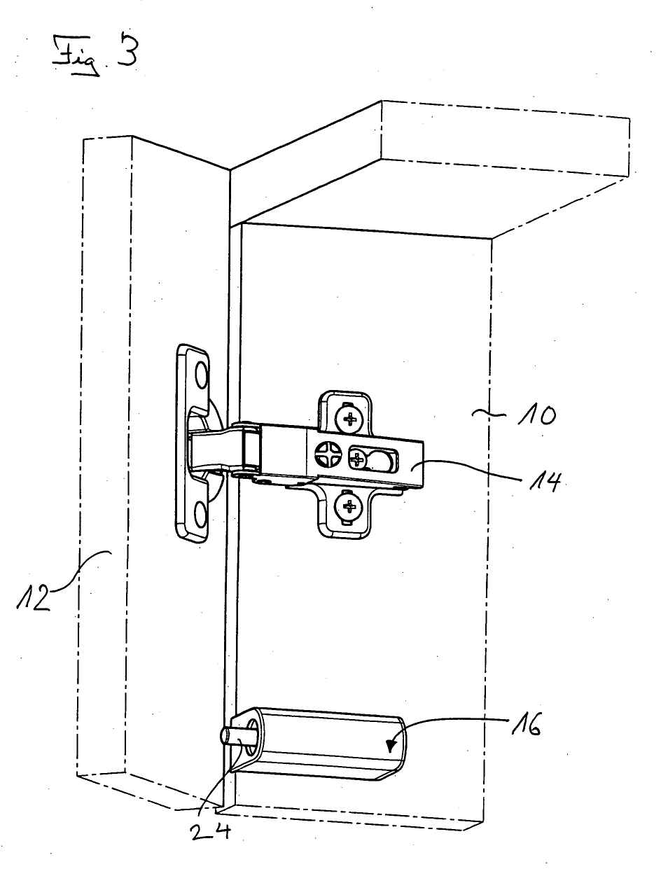

FIG. 4: a top view of an adaptor according to the invention, corresponding to that shown in FIG. 1;

FIG. 5: a lateral view of a closing cap for closing an accommodation recess;

FIG. 6: a section along the section line VI-VI in FIG. 4;

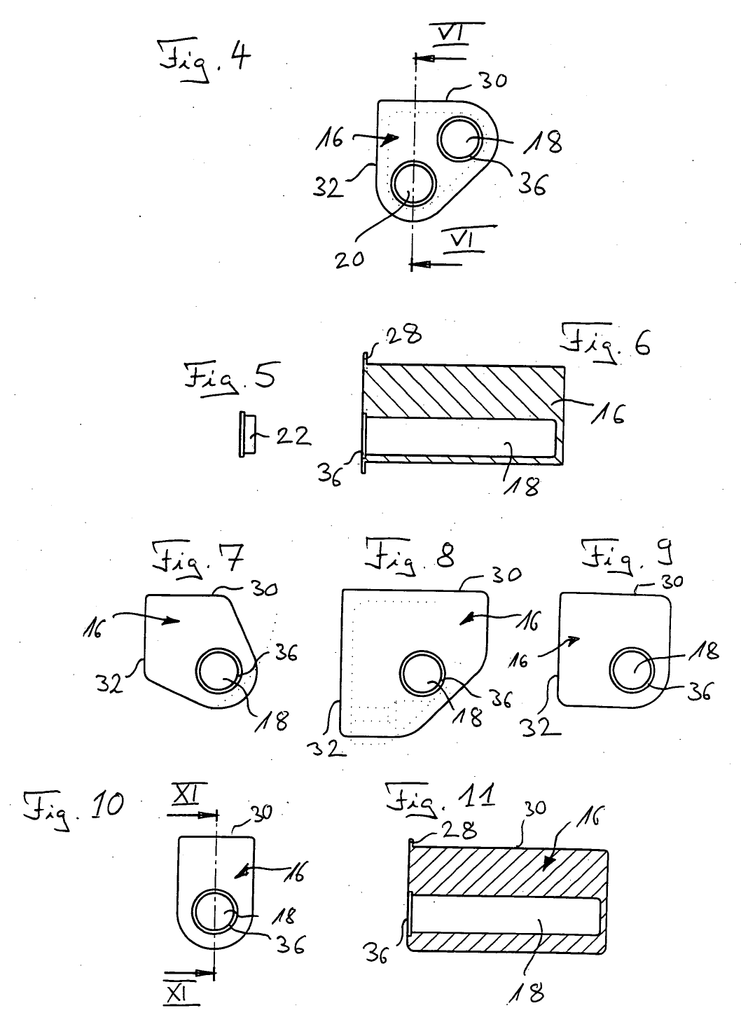

FIGS. 7, 8, 9: top views of adaptors of various designs;

FIG. 10: a further alternative design of an adaptor; and

FIG. 11: a section along the section line XI-XI.

FIG. 1 shows a perspective view of a furniture carcass 10 with a door 12 fitted by way of a hinge 14. In a first embodiment, an adaptor 16 according to the invention is installed in the corner region of the furniture carcass 10. The top of the furniture carcass shown can also be an intermediate bottom. The embodiment of the adaptor as shown in FIG. 1 can be most easily explained by means of FIGS. 4 to 6. As shown in FIG. 4, two accommodation recesses 18 and 20 are aligned parallel in relation to each other. The cross section of the adaptor essentially corresponds to a triangle with two rounded corners. This shape results in two plane attachment surfaces 30 and 32, positioned at right angles in relation to each other, which, as shown in FIG. 1, can be fitted in a corner region of a furniture carcass and can be affixed by means of adhesive (not shown in detail), for example with adhesive tape with double-sided adhesive action. Braking deceleration devices are fitted into the accommodation recesses and are accommodated for example in a press fit. FIG. 2 shows an example of a corresponding braking deceleration device, wherein such braking deceleration devices are already adequately known and described in detail in the European patent application EP 1 006 251 A1. They comprise a plunger 24 and a housing 26, which is filled with a corresponding damping liquid. In the embodiment shown, the viscosity of this liquid is 20,000 cSt. In the front region of the housing 26, on the braking deceleration device, a flange 34 is arranged which can be inserted into an indentation 36 in the form of a blind hole, or a ring-shaped depression in the region of the accommodation recess 18 or 20. To the extent that in the adaptor according to FIG. 4 only one braking deceleration device 18 or 20 is to be used, the other accommodation recess can be closed off via a closing cap, an example of which is shown in FIG. 5. At the front edge of the adaptor 16 there is a circumferential rim or flange 28 which makes possible exact alignment of the adaptor in the installed state. This is shown in FIG. 1 where the circumferential flange 28 is affixed to the front edge of the furniture carcass. This ensures precise alignment of the adaptor and thus also of the braking deceleration device.

FIGS. 7, 8 and 9 show other embodiments of adaptors 16 wherein only one accommodation recess 18 is provided in the adaptor 16. In all these embodiment variants, two attachment surfaces 30 and 32 are provided, which are aligned at right angles to each other. The cross section of the adaptor in the embodiment according to FIG. 9 essentially corresponds to that of a square, wherein two corner regions are only slightly rounded and one corner region is more rounded.

FIG. 3 shows another installation configuration of an adaptor 16. This shows an adaptor in an embodiment variant according to that shown in FIG. 10, wherein in this case only one attachment surface 30 is provided, by way of which the adaptor can be affixed by adhesion onto the furniture carcass. This embodiment variant provides for only one accommodation recess 18. Instead of a fully circumferential flange 28, in this embodiment only a rim region 28 in the region of the attachment surface is preferred, which flange also serves to facilitate the installation of the adaptor 16.

1. An adaptor for a braking deceleration device for doors or movable furniture parts, which essentially comprises a plunger which can be pushed into a housing against a braking force, with an adaptor body, characterised in that
in the adaptor body at least one accommodation recess for accommodating the housing of the braking deceleration device is made, and in that the adaptor body comprises at least one smooth external surface by way of which it can be fixed to the frame or furniture carcass by means of a suitable adhesive.

2. The adaptor according to claim 1, characterised in that the adaptor body comprises two smooth external surfaces which are essentially aligned at right angles in relation to each other.

3. The adaptor according to claim 1 or 2, characterised in that the adaptor body comprises an essentially triangular cross section.

4. The adaptor according to any one of claims 1 to 3, characterised in that two accommodation recesses are made in the adaptor body.

5. The adaptor according to any one of claims 1 to 4, characterised in that an adhesive tape with double-sided adhesive action is used as an adhesive.

6. The adaptor according to any one of claims 1 to 5, characterised in that the front end of the accommodation recess provided in the adaptor is of pedestal-like design, and in that the braking deceleration device comprises a rim tightly fitted in the pedestal-like recess.

7. The adaptor according to any one of claims 1 to 6, characterised in that on the side on which the accommodation recess is provided, the adaptor body comprises a circumferential rim.
